(19) United States
(12) Patent Application Publication
(10) Pub. No.: US 2024/0159916 A1
(43) Pub. Date: May 16, 2024

(54) Method for Detecting Multi-Level Roads on the Basis of GNSS

(71) Applicant: Robert Bosch GmbH, Stuttgart (DE)

(72) Inventor: Tomasz Bien, Ludwigsburg (DE)

(21) Appl. No.: 18/496,849

(22) Filed: Oct. 28, 2023

(30) Foreign Application Priority Data
Nov. 11, 2022 (DE) 10 2022 211 976.2

(51) Int. Cl. G01S 19/42; G01S 19/25; G01S 19/27; G01S 19/39

(52) U.S. Cl. CPC G01S 19/42; G01S 19/258; G01S 19/27; G01S 19/396

(57) ABSTRACT

A method for detecting multi-level roads on the basis of GNSS includes (i) acquiring actually tracked GNSS satellites and the theoretically trackable GNSS satellites at a location, (ii) generating a point cloud representation using the actually tracked and the theoretically trackable GNSS satellites, (iii) discovering which theoretically trackable GNSS satellites cannot be tracked at the location, and (iv) detecting a road level as part of the detected positions when, in the point cloud representation, the discovered GNSS satellites are situated in a particular region corresponding to a roadway-like pattern.

This application claims priority under 35 U.S.C. § 119 to patent application no. DE 10 2022 211 976.2, filed on Nov. 11, 2022 in Germany, the disclosure of which is incorporated herein by reference in its entirety.

### BACKGROUND

The present disclosure relates to a method for detecting multi-level roads on the basis of GNSS. Also disclosed are a control device, a computer program, a machine-readable storage medium, and a geolocation system for a vehicle. The disclosure can in particular be used in GNSS-based locating systems for autonomous or semi-autonomous driving.

GNSS is the abbreviation for the global navigation satellite systems for position determination and navigation on the Earth and in the air by receiving navigation satellite signals.

When determining the position, it should be noted that each navigation satellite transmits a navigation satellite signal at a high carrier frequency of several hundred MHz (e.g., the L1 carrier frequency of 1575) that can only be received in open areas (i.e., free from obstructions) due to its extremely short wavelength.

When navigating, it should be noted that the navigation map is typically configure two-dimensional (2D) with no indication of height information, so a vehicle could be falsely controlled or guided when traveling on a road having multiple levels (FIG. 1).

Although a diverse range of sensor technology is already used in autonomous driving, there are currently no good solutions for recognizing positions on multi-level roads.

Proceeding therefrom, the object of the present disclosure is to alleviate or at least partially solve the problems described in relation to the prior art. In particular, a method for detecting positions on multi-level roads is intended to be provided. This is particularly significant for autonomous driving, because, in addition to positional accuracy, autonomous driving places particularly high demands on the safety and integrity and/or correctness of the geolocation information.

### SUMMARY

To this end, a method for detecting positions on multi-level roads on the basis of GNSS, comprises the following steps:
a) acquiring actually tracked GNSS satellites and theoretically trackable GNSS satellites at a location,
b) generating a point cloud representation using the actually tracked and the theoretically trackable GNSS satellites,
c) discovering which theoretically trackable GNSS satellites cannot be tracked at the location,
d) detecting a road level as part of the detected positions when, in the point cloud representation, the discovered GNSS satellites are situated in a particular region corresponding to a (predetermined) roadway-like pattern.

The method described is particularly suitable for autonomous driving. It is particularly advantageous if an autonomously driving motor vehicle having a locating system is provided with a GNSS receiver for performing the method as described. It is also advantageous if the GNSS receiver can simultaneously receive GNSS signals from different GNSS systems.

A multi-level road can, e.g., be a road having two or at least three levels, typically constructed vertically or perpendicularly above one another such that an upper level can obscure the propagation of navigation satellite signals to a lower level of the multi-level road, which can result in the tracking of certain GNSS satellites being lost when a vehicle is traveling on the lower level.

Using the method described, the determination of the GNNS satellites lost for tracking can in turn contribute to detecting the lower level.

It is therefore an essential concept of the disclosure by way of the discovery of the GNSS satellites obscured by an upper level of a multi-level road to detect positions again on a level situated below the upper level. In this context, discovery of the obscured GNSS satellites is performed by way of pattern recognition on a point cloud representation generated using GNSS satellites.

Preferably, the method described is activated if on the basis of map data (data stored in the vehicle with respect to roads), information is already available that the location is on a road with multiple levels, although it cannot yet be determined with sufficient certainty on which level of the road the location is situated.

According to step a), actually tracked GNSS satellites and theoretically trackable GNSS satellites are acquired at one location.

GNSS is the abbreviation for global navigation satellite systems. Currently, four different GNSS systems are available, specifically GPS, GLONASS, Galileo, and BeiDou. Each GNSS comprises a plurality of GNSS satellites evenly distributed in the sky and/or in orbit and traveling according to a known movement pattern. It is therefore possible that the positions of GNSS satellites are pre-determined according to location, time, and movement patterns. For this purpose, the movement patterns are available to the public and can be pre-downloaded (e.g. from the International GNSS Service (ISG)) and/or stored, regularly updated, in a storage means. The GNSS satellites, the positions of which are determined in advance (e.g., by way of calculation) with respect to a location and a time interval, as well as according to their movement patterns, are referred to herein as theoretically trackable GNSS satellites. The theoretically trackable GNSS satellites thus represent the GNSS satellites that should appear in a given time interval and in the field of view of a specific location. The appearance of the theoretically trackable GNSS satellites is therefore independent of the signal receiving conditions (i.e., not considering obstacles).

On the other hand, the actually tracked GNSS satellites are the GNSS satellites, which are only acquired by the reception of GNSS signals. In the present context in particular, the GNSS signals refer to the signals transmitted by GNSS satellites, which can only be received unhindered during their propagation due to their extremely short wavelength. The acquisition of the actual GNSS satellites is thus heavily dependent on the signal receiving conditions.

It is possible that the position of an actually tracked GNSS satellite can be determined from the almanac and ephemeris data included in the received GNSS signal, as well as correction data. Further, it is possible for a location to be determined from the determined positions of four tracked GNSS satellites of the same GNSS.

Therefore, according to step a), the actually tracked and theoretically trackable GNSS satellites can be acquired, e.g. using the following substeps:
receiving GNSS signals,
determining the positions of the actually tracked GNSS satellites, the current location and the current time on the basis of the received GNSS signals, and
calculating theoretically trackable GNSS signals at the current location and in the current time on the basis of the corresponding movement patterns.

The theoretically trackable GNSS satellites can be used as references and, by comparison with the tracked GNSS satellites, show which GNSS satellites are not being tracked. These untracked GNSS satellites are the GNSS satellites to be discovered in step c) which indicate with a high likelihood that an upper level is hindering the reception of affected GNSS signals.

In order to simplify the subsequent comparison and discovery, according to step b), a point cloud representation is generated using the actually tracked and theoretically trackable GNSS satellites.

The point cloud representation can mean visualizing the acquired GNSS satellites in the form of an image. To this end, it is possible that the positions of the acquired GNSS satellites are marked point-by-point on a coordinate system. In this way, a visual point cloud representation is created in which each point represents the position of an acquired GNSS satellite. To this end, it is also possible that the positions of the acquired GNSS satellites are represented point-by-point in a sky view. In this way, the acquired GNSS satellites can be marked point-by-point according to their elevation and their azimuth in a spherical coordinate system.

It is also possible that the positions of the acquired GNSS satellites are marked on the coordinate system such that the GNSS satellites acquired by way of the reception of GNSS signals are marked with a symbol as actually tracked GNSS satellites, while the GNSS satellites acquired by calculation are marked as theoretically trackable GNSS satellites with another symbol. A visual and intuitive overview of the GNSS satellites can therefore be created at the current location and in the current time interval.

On the basis of the generated point cloud representation, it is discovered according to step c) which theoretically trackable GNSS satellites cannot be tracked.

The number of GNSS satellites tracked is typically the same as (without obstacles), or smaller than (with obstacles), the number of trackable GNSS satellites.

This can mean that the tracked and the trackable satellites should occur in pairs and (almost) overlapping in the point cloud representation, especially if the GNSS satellites are tracked by receiving GNSS signals by way of a high precision GNSS receiver.

This can also mean that a GNSS satellite cannot be tracked when only a single (calculated) GNSS satellite appears in the point cloud representation. In other words: The GNSS satellites that appear individually (i.e., not in pairs) in the point cloud representation represent the theoretically trackable GNSS satellites that are not actually tracked (due to obstacles). These individually appearing GNSS satellites are thus the discovered GNSS satellites.

It is then determined whether the discovered GNSS satellites cannot be tracked due to the occlusion thereof by an upper level of a multi-level road. This can be performed by way of pattern recognition on the generated point cloud representation.

According to step d), a road level is detected as part of the detected positions when, in the point cloud representation, the discovered GNSS satellites are situated in a particular region which corresponds to a (predetermined) roadway-like pattern.

The roadway-like pattern is typically an elongate shape that simulates the roadway. If the untracked GNSS satellites are predominantly within such an elongate shape, this is highly likely to indicate that a vehicle equipped with a GNSS receiver is traveling on a lower level of a multi-level road such that at least one upper level of the multi-level road prevents the GNSS receiver of the vehicle receiving certain GNSS signals, which are emitted by GNSS satellites, the positions of which in the point cloud representation appear in this elongate shape. A road level can therefore be detected as part of the detected positions.

The phrase “part of the detected position” means that an item of positional information provided prior to performing the method, which contains two-dimensional coordinates on a world surface on the basis of which the level of the road cannot be distinguished, is supplemented by an item of level information, which indicates on which road level of a multi-level road the location is situated.

Recognition of the elongate shape formed by the untracked GNSS satellites in the point cloud representation can be performed by one of the known approaches in the field of visualization, image processing and image recognition.

The method described enables positioning and navigation through reception of invisible GNSS signals taking account of environmental impairments, particularly roads with multiple levels, to be viewed and analyzed in a visual and intuitive manner.

In particular, if it has been recognized on the basis of a position that a location (e.g., the location of a vehicle of which the position is determined) is on a road with a plurality of levels, but it is not known on which of the levels the location is situated, then the method described can be applied. For example, it can be recognized that the vehicle is on a topmost level if no obscuration of satellites corresponding to a roadway-like pattern has been discovered. If such an obscuration corresponding to a roadway-like pattern has been recognized, then it can thereby be recognized that the location must be on a lower level, over which one (or more) further levels are arranged which cause the obscuration.

To this end, the trackable and tracked GNSS satellites acquired using conventional methods are represented as points in a point cloud representation. The task of detecting positions on multi-level roads, which can only be achieved in a complex and computationally intensive way (or not at all) by way of sensor technology, can therefore then be solved using the described method steps in a simplified manner by calculation. Doing so only requires a software update to recognize the elongate shape in the point cloud representation. Recognition of the elongate shape in an image is a relatively simple task in the field of computer vision, for which many known approaches are available.

Since navigation already takes place according to a navigation map, it is also possible for multi-level roads to be marked in advance in the navigation map. Therefore, the described method need not be performed continuously during the travel of a vehicle. To this end, the proposed method can be triggered and performed temporarily merely if, according to the navigation map, it is recognized (e.g., by a geolocation system) that the positioning relates to a multi-level road on the navigation map. It can thereby be detected whether the affected vehicle is traveling on a lower level of the multi-level road. This is particularly significant for autonomous driving, because, in addition to positional accuracy, autonomous driving places particularly high demands on the safety and integrity and/or correctness of the geolocation information.

Although the steps herein are denoted by the letters a) to d) in a specific order, it is not necessary to always adhere to this order. For example, the individual steps can often be repeated independently of one another and/or can also sometimes be omitted in a case of repetition. It is possible that the steps are performed at least partially overlapping in time.

It is preferred if, during step a), the actually tracked GNSS satellites are acquired by receiving GNSS signals.

It is also preferred if the theoretically trackable GNSS satellites are calculated in step a) using almanac data and ephemeris data.

It is particularly preferred when the almanac data and ephemeris data for calculating the theoretically trackable GNSS satellites are acquired via an internet and/or mobile communications network.

Currently, the almanac and ephemeris data for determining the positions of GNSS satellites can be obtained both by receiving GNSS signals from the sky as well as by receiving mobile communications and/or WLAN signals via, e.g., an internet and/or mobile communications network on the Earth. It is therefore possible that, during step a), the actually tracked GNSS satellites are acquired by way of the reception of GNSS signals while the theoretically trackable GNSS signals are acquired by way of the reception of cellular and/or WLAN signals on the Earth containing the almanac and ephemeris data. The tracked and the trackable GNSS satellites can thereby be acquired separately via two different routes. This is particularly significant for the subsequent generation of a precise point cloud representation, since the mutual interference and uncertainty in the reception of almanac and ephemeris data can be avoided through separate routes.

Moreover, the ephemeris data for determining theoretically trackable GNSS satellites can already be received prior to performing the described method and periodically updated via an internet and/or mobile communications network, since the ephemeris data can be valid within a given time interval (e.g., in the case of GPS, within two hours).

The almanac data are acquired in a list with path data of the navigation satellites that are less accurate but valid longer than the ephemeris data. The almanac data are not necessary for position determination but are useful for checking the integrity of the transmitted signals. Furthermore, the almanac data, which are also available from the internet, are used for planning GNSS sessions to e.g., determine whether and when particularly good results can be achieved at a point on the Earth's surface. Therefore, it is particularly advantageous if the almanac data are downloaded from the internet, stored in a storage means, and regularly updated.

It is particularly advantageous if a GNSS receiver is used to perform method step a) which can receive both GNSS signals from the GNSS satellites in the sky, as well as mobile communications and/or WLAN signals via an internet and/or mobile communications network on the Earth.

In this context, the term “mobile communications signal” in particular means the signal transmitted from a base station of a mobile communications operator and can be received by the GNSS receiver by way of, e.g., a SIM card.

In this context, the term “WLAN signal” in particular means the signal that can be transmitted from a hotspot and received by a WLAN interface of the GNSS receiver.

It is preferred if the pattern is specified as an elongate shape. The elongate shape can therein be a rectangular or long oval shape.

It is preferred if, during step a), all of the GNSS satellites that are in the field of view of the location are acquired independently of a particular GNSS. This can mean that all GPS, GLONASS, Galileo and BeiDou satellites in the location field of view are acquired so that a point cloud representation that is as dense as possible can be generated.

It is preferable if a control device for the GNSS receiver is configured to perform the described method.

It is also preferable if a computer program is used to perform a method described herein. In other words, this relates in particular to a computer program (product) comprising commands which, when the program is executed by a computer, prompt said computer to perform a method described herein.

It is also preferred if a machine-readable storage medium is used, on which the computer program proposed herein is stored. Conventionally, the machine-readable storage medium is a computer-readable data medium.

It is particularly preferred if the locating system for a vehicle is configured to perform a method described herein.

### BRIEF DESCRIPTION OF THE DRAWINGS

The solution presented herein and the technical environment thereof are explained in greater detail hereinafter making reference to the drawings. It should be noted that the disclosure is not intended to be limited by the exemplary embodiments disclosed. In particular, unless explicitly stated otherwise, it is also possible to extract partial aspects of the factual subject matter described in relation to the drawings and to combine them with other components and/or knowledge based on other drawings and/or the present description. Schematically shown are:

FIG. 1 a multi-level road,

FIG. 2 a point cloud representation; and

FIG. 3 a flow diagram of the method described.

### DETAILED DESCRIPTION

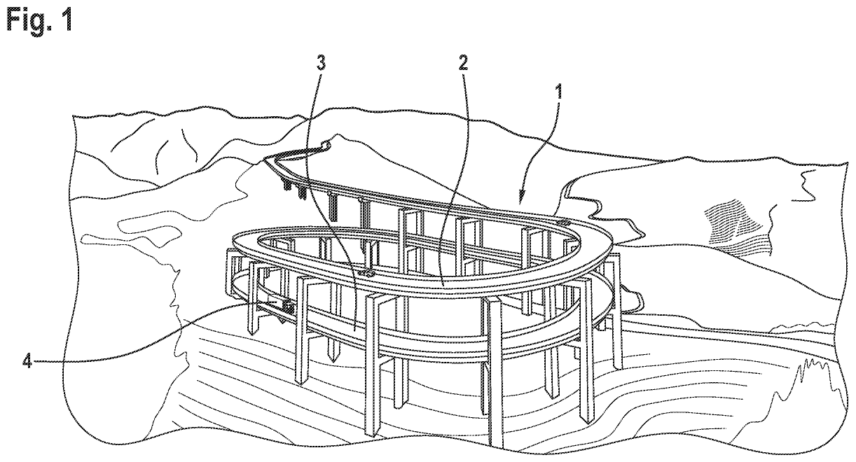

FIG. 1 schematically illustrates a multi-level road 1 having an upper level 2 and a lower level 3. The upper level 2 is built vertically above the lower level 3 so that the upper level 2 can obscure the propatation of GNSS signals to the lower level 3. This can result in affected GNSS satellites not being able to be tracked when a vehicle 4 is traveling on the lower level 3.

It should further be noted that a navigation map is typically configured to be two-dimensional (2D) without indication of height information, so that the vehicle 4 can be falsely guided because it cannot be recognized on which level the vehicle 4 is situated.

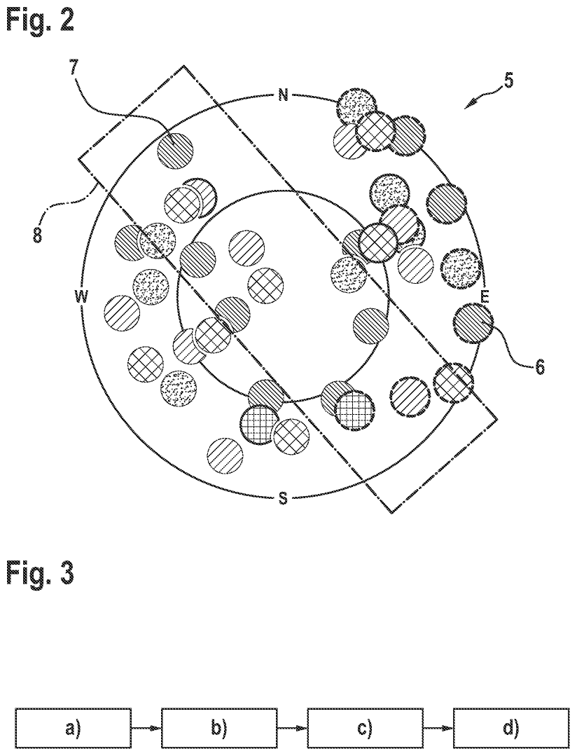

FIG. 2 shows a point cloud representation 5 generated using the described method for solving the problem outlined in relation to FIG. 1.

The point cloud representation 5 comprises a plurality of points 6, 7 corresponding to the positions of acquired GNSS satellites in a spherical coordinate system. The GNSS satellites actually tracked at one location can be acquired by the direct reception of GNSS signals, whereas the theoretically trackable GNSS satellites can be acquired at the same location indirectly by, e.g., calculating ephemeris data obtained indirectly via an internet and/or mobile communications network.

It can be seen in FIG. 2 that some obscured dots 7 appear within an elongate shape 8. The obscured points 7 correspond to the GNSS satellites obscured by the upper level 2, while the elongate shape 8 represents the upper level 2. This can mean that the vehicle 4 is traveling on the lower level 3 when, in the point cloud representation 5, it is recognized that the obscured points 7 are within the elongate shape 8. Otherwise, the vehicle 4 is traveling on the upper level 2.

The method described enables positioning and navigation by way of the reception of non-visible GNSS signals taking account of multi-level roads 1 to be viewed and analyzed, using a point cloud representation 5, in a visual and intuitive manner.

The task of detecting positions on multi-level roads, which can only be solved in a complex and computationally intensive way (or not at all) by way of sensor technology, can therefore then be solved using the described method steps in a simplified manner by calculation. Doing so only requires a software update in order to recognize the obscured points 7 in the elongate shape 8 in the point cloud representation 5. The recognition of the obscured points 7 in the elongate shape 8 is a relatively simple task in the field of computer vision, for which many known approaches are available.

This is particularly significant for autonomous driving, because, in addition to positional accuracy, autonomous driving places particularly high demands on the safety and integrity and/or correctness of the location information.

FIG. 3 shows a flow chart of the described method. The method steps a), b), c), and d), which are performed in succession to determine a road level on which the location is situated as part of the detected position can be seen.

What is claimed is:

1. A method for detecting multi-level roads on the basis of GNSS, comprising:
a) acquiring actually tracked GNSS satellites and theoretically trackable GNSS satellites at a location;
b) generating a point cloud representation using the actually tracked and theoretically trackable GNSS satellites;
c) discovering which theoretically trackable GNSS satellites cannot be tracked at the location; and
d) detecting a road level as part of the detected positions when, in the point cloud representation, the discovered GNSS satellites are situated in a particular region corresponding to a roadway-like pattern.

2. The method according to claim 1, wherein:
during step a), the actually tracked GNSS satellites are acquired by receiving GNSS signals.

3. The method according to claim 1, wherein:
during step a), the theoretically trackable GNSS satellites are calculated using almanac data and ephemeris data.

4. The method according to claim 3, wherein the almanac data and ephemeris data for calculating the theoretically trackable GNSS satellites are acquired via an internet and/or mobile communications network.

5. The method according to claim 1, wherein the pattern is specified as an elongate shape.

6. The method according to claim 1, wherein:
during step a), all of the GNSS satellites in the field of view of the location are acquired.

7. A control device for the GNSS receiver configured to perform a method according to claim 1.

8. A computer program for performing a method according to claim 1.

9. A machine-readable storage medium on which the computer program according to claim 8 is stored.

10. A locating system for a vehicle which is configured to perform a method according to claim 1.
